(19) United States
(12) Patent Application Publication
(10) Pub. No.: US 2005/0064848 A1
(43) Pub. Date: Mar. 24, 2005

(54) Method of classifying and storing call durations according to a calling partner

(76) Inventors: Ji-Hwan Kim, Seoul (KR); Byung-Jin Kim, Seoul (KR)

Correspondence Address: MORGAN & FINNEGAN, L.L.P., 3 World Financial Center, New York, NY, 10281-2101, US

(21) Appl. No.: 10/925,236

(22) Filed: Aug. 23, 2004

(30) Foreign Application Priority Data
Aug. 25, 2003 (KR) 2003-58646

(51) Int. Cl. H04M 1/56

(52) U.S. Cl. 455/414.1; 379/142.1; 370/410

(57) ABSTRACT

The present invention relates to a method of classifying and storing the call durations of a mobile communication terminal and, more particularly, to a method of classifying and storing call durations, which classifies call durations, call time categories, etc. related to calls with calling partners stored in the address book of the mobile communication terminal, so that the user can recognize his or her call pattern and control the amount of call traffic, thus efficiently utilizing the mobile communication terminal. When an incoming or outgoing call is started, a calling partner of the call is identified, and a timer is operated to count call duration. When the call is terminated, the timer is stopped, and the actual call duration with the calling partner is calculated, thus classifying the call duration. The classified call duration is stored in the information area according to the calling partner of the call.

### BACKGROUND OF THE INVENTION

1. Field of the Invention

The present invention relates, in general, to a method of classifying and storing the call durations of a mobile communication terminal and, more particularly, to a method of classifying and storing call durations according to a calling partner.

2. Description of the Related Art

Conventional mobile communication terminals provide call duration information on calls made and received to users. More specifically, such a mobile communication terminal provides call duration information, such as total incoming call duration, total outgoing call duration, and last call duration, as well as total call duration obtained by summing the duration of all incoming and outgoing calls. As described above, the conventional terminal provides a user with only temporal information about calls.

However, when a user ascertains his or her own call pattern and wants to control the amount of call traffic, the conventional method of providing call duration information is of limited usefulness. That is, the conventional call duration information provision method is disadvantageous in that, since it does not provide the user with detailed call duration information, such as a calling partner with whom the user communicates most using the mobile terminal, call duration for which the user communicates with the calling partner, and call durations according to time frame and day, the conventional method cannot satisfy the user's desire for detailed call duration information.

### SUMMARY OF THE INVENTION

Accordingly, the present invention has been made keeping in mind the above problems occurring in the prior art, and an object of the present invention is to provide a method of classifying and providing call duration information according to the calling partner, which classifies call durations into a total call duration, a total outgoing call duration, and a total incoming call duration according to the calling partner and stores the classified call duration information into a storage area, and which classifies the call duration information according to a day of the week (e.g., Sunday, Monday, etc.) and time frame within a day (e.g., 06:00˜12:00 AM etc.) and also stores the classified call duration information into a storage area for the corresponding calling partner.

In order to accomplish the above object, the present invention provides a method of classifying and storing the call duration information according to a calling partner, which operates a timer at the beginning of a call with the calling partner to count a call duration, and stops the timer and calculates a call duration counted at that time when the call is terminated. Further, the calling partner may be searched, and the calculated call duration is added to total call duration of the corresponding calling partner and stored in a storage area. The above procedure may be performed when the phone number of the searched other party exists in an address book stored in the mobile communication terminal. This procedure may be applied to both outgoing and incoming calls.

In an aspect of the invention, the calculated call duration may be separately added according to whether the call is an outgoing call or an incoming call, when the calculated call duration is added to the total call duration with the calling partner.

The calculated call duration, calculated after termination of the call, may be added to the total call duration, and stored in a total call duration storage area in the terminal. The call duration, calculated after the termination of the call, may be classified according to the day and time frame, the classified call duration may be added to the total call duration according to the day and time frame, and the added call duration may be stored in total call duration storage areas according to the day and time frame provided in the terminal. The classifying, adding and storing of the calculated call duration according to the day and time frame may be performed with respect to outgoing calls. The total call duration according to the calling partner may be initialized at each month.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart of a method of classifying and storing call durations according to a calling partner;

FIG. 2 is a flowchart of a process of identifying the calling partner of a call;

FIGS. 3a to 3c are exemplary tables in which classified call durations are to be stored; and

FIGS. 4a to 4e are examples of actual screen displays of a mobile communication terminal that implements the method of the present invention to show the classified call durations.

### DESCRIPTION OF THE PREFERRED EMBODIMENTS

Hereinafter, embodiments of the present invention will be described in detail with reference to the attached drawings.

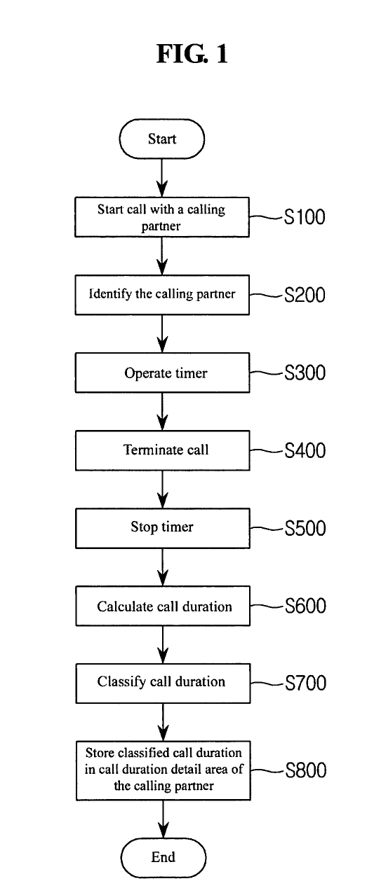

FIG. 1 is a flowchart of a method of classifying and storing call duration information with respect to a calling partner according to an embodiment of the present invention.

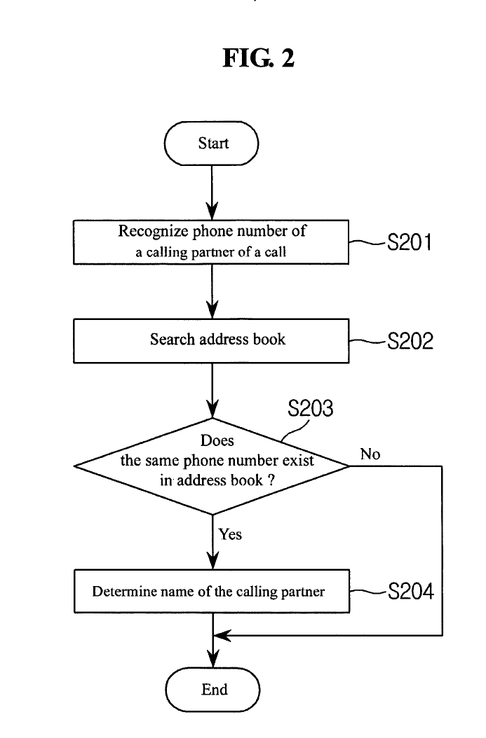

When the user of a mobile communication terminal starts to communicate by an outgoing call or an incoming call at step S100, the terminal identifies the calling partner with whom the user communicates using the mobile communication terminal at step S200. Alternatively, the identifying step of the calling partner may be performed after the call is terminated. The identifying step is described in detail with reference to the flowchart in FIG. 2.

In FIG. 2, the terminal recognizes the phone number of the calling partner, which is unique with identifiable caller Identification (ID), at step S201. The terminal searches an address book in a storage area for the recognized phone number at step S202, and determines whether the recognized phone number of the calling partner exists in the address book at step S203. If the recognized phone number exists in the address book, the terminal determines the name of the calling partner allocated to the recognized phone number of the address book at step S204. Therefore, in order for the terminal to calculate call durations of a calling partner, the terminal must identify corresponding calling partner at the time the outgoing or incoming calls are made.

Referring back to FIG. 1, after the step of identifying the calling partner is performed, the terminal operates a timer therein to count a call duration at step S300. After the outgoing or incoming call has terminated at step S400, the terminal stops the timer to stop counting of the call duration at step S500, and calculates the call duration at step S600. Calculating the call duration using a timer is well known in the art and a detailed description is omitted.

However, unlike the conventional method, the present invention classifies the calculated call duration into several categories such as a total incoming call duration, a total outgoing call duration and a total call duration, according to the calling partner. The present invention further classifies the total call duration according to the day (e.g., Sunday, Monday etc.) and time frame (e.g., 6:00˜12:00 AM etc.) at step S700.

The time frame may be classified in such a way that a time framed of 6:00 to 12:00, a time frame of 12:00 to 19:00, a time frame of 19:00 to 24:00, and a time frame of 24:00 to 6:00 may be designated as a morning period, an afternoon period, an evening period and a midnight period, respectively.

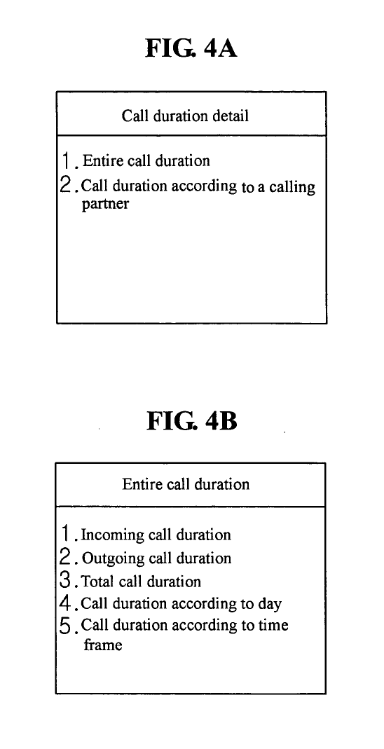

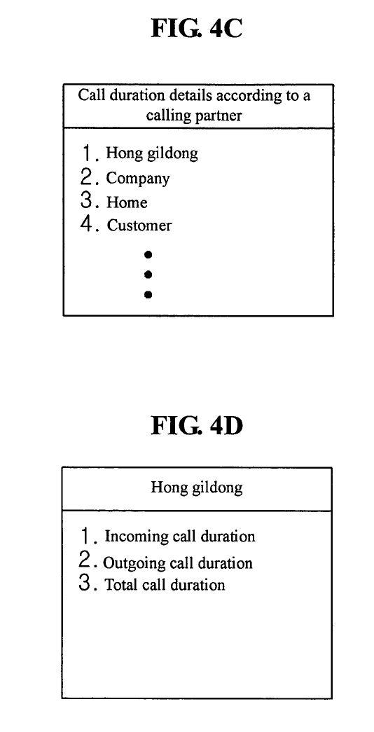

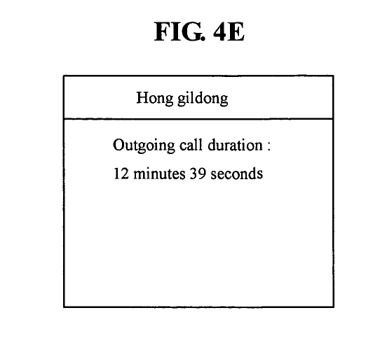

The call duration classified through the above procedure is stored in the area of the storage area (i.e., a memory) of the terminal. In particular, the call duration details may be separately stored. The storage area is divided into an area for entire call duration details in which durations classified for all calls regardless of calling partners are stored, and an area for call duration details according to each of the calling partners in which call durations are classified and stored according to a calling partner, as shown in the call duration detail screen of FIG. 4a.

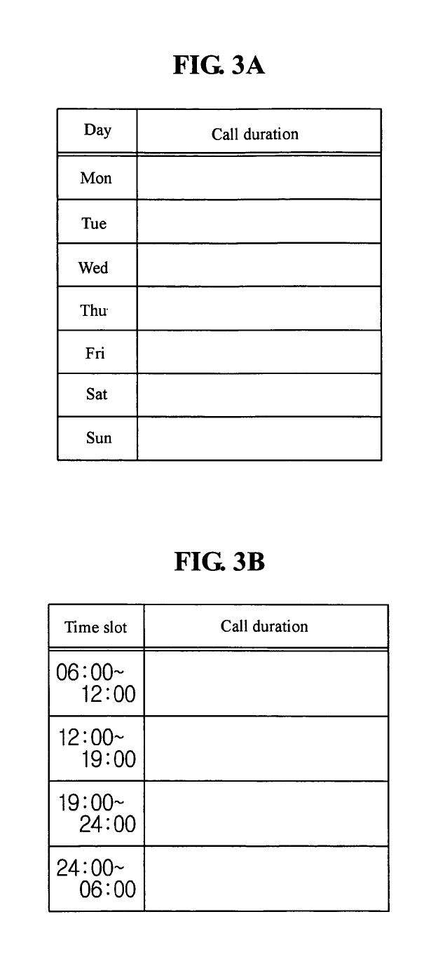

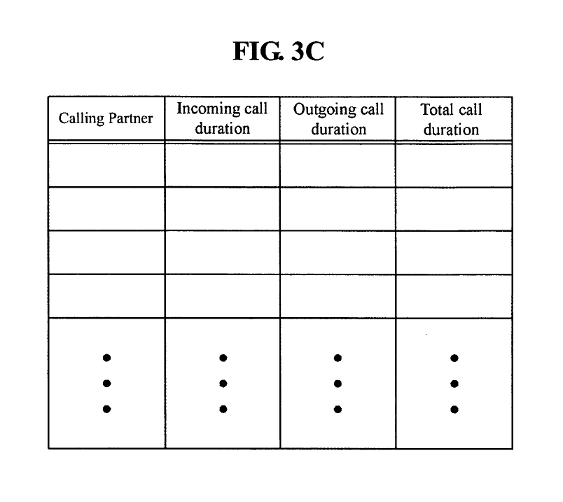

As shown in FIG. 4b, the entire call duration details are classified into call duration details according to the day and time frame, in addition to incoming, outgoing and total call duration details, and the classified call duration details are stored in corresponding detail areas. The call durations classified according to the day and time frames may be stored in the memory of the terminal in the form of tables as shown in FIGS. 3a and 3b, respectively. Further, call duration details according to the calling partner are classified according to the calling partner, and stored in the form of a table as shown in FIG. 3c. The call durations stored in this way may be initialized at each month.

The process of ascertaining call durations classified according to the present invention is described in detail with reference to an embodiment.

When the user desires to ascertain call duration with respect to calls with a person named “Hong Gildong”, whose name is stored in the address book of the terminal, the user can ascertain the desired call duration using the mobile communication terminal that implements the method of the present invention. The terminal may be configured to display a menu screen that shows a call duration detail menu as shown in FIG. 4a. The user may select either option 1 (i.e., entire call duration) or option 2 (i.e., call duration according to a calling partner) as shown in FIG. 4a. If the user selects the option 1, the terminal displays a screen that shows an entire call duration as shown in FIG. 4b. If, however, the user selects the option 2, the terminal displays a screen that shows a list of names for the calling partners as shown in FIG. 4c.

Referring to FIG. 4c, in the case of call duration details according to a calling partner, other calling parties with whom the user communicates using the mobile communication terminal during a month, are listed with an order by, for example, most recent calls. The user may selects option 1 in FIG. 4c to select “Hong Gildong” and the terminal may display a screen that shows a detailed call information with “Hong Gildong” as shown in FIG. 4d. The user may further selects an option in FIG. 4d to view call duration details with the calling partner (i.e., Hong Gildong), including incoming call duration (option 1), outgoing call duration (option 2) and total call duration (option 3), as shown in FIG. 4d. If the user calls “Hong Gildong”, the call duration is added to both the outgoing call duration and the total call duration in the storage area of “Hong Gildong” in the table of FIG. 3c. If the user wants to further ascertain the outgoing call duration with “Hong Gildong” for a month, the outgoing call duration detail area (i.e., option 2) of FIG. 4d is selected, so that the terminal displays the outgoing call duration as shown in FIG. 4e.

The call duration with “Hong Gildong” is also stored in the entire call duration detail area of the storage area and may be displayed as one of the menu areas of FIG. 4a. When the corresponding call is an outgoing call, the duration of the outgoing call is added to both in the total outgoing call duration and in the total call duration in the storage area in the form of table of FIG. 3c.

The outgoing call duration with “Hong Gildong” may be added to the call duration area according to the day as shown in FIG. 3a depending on the day when the call is made to “Hong Gildong”, and stored therein. Further, the call duration may be added to the call duration area according to the time frame as shown in FIG. 3b depending on the time frame during which the call is made to “Hong Gildong”, and stored therein. As an embodiment, stored call durations are limited only to outgoing call durations in FIGS. 3a and 3b. In this case, if an incoming call is received, a process of classifying and storing incoming call duration according to day and time category is not executed.

Through the method as described above, the user of the mobile communication terminal that implements the method classifies the call durations according to a calling partner and stores the call duration information in a storage area. The user further classifies and stores the call durations according to the day and time frame.

As described above, the present invention provides a method of classifying and storing call durations according to a calling partner, which classifies call durations according to the calling partner and provides a user with call durations information according to the day and time frame, thus allowing the user to recognize his or her call pattern and helping the user to control the call traffic. Therefore, the present invention is advantageous in that the user recognizes his or her call pattern and can select a suitable billing plan and efficiently utilize a mobile communication terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of using a call duration information of a call made between the user of a mobile communication terminal and a calling partner, comprising:
counting a call duration by operating a timer at the beginning of the call;
stopping the timer and calculating the call duration counted when the call is terminated;
identifying the calling partner of the call;
classifying the calculated call duration into a plurality of categories including a category associated with the calling partner; and
adding the calculated call duration to a total call duration associated with the calling partner and storing the total call duration into a memory of the mobile communication terminal.

2. The method of claim 1, wherein the adding and storing of the calculated call duration is performed when a phone number of the identified calling partner exists in an address book stored in the memory of the mobile communication terminal.

3. The method of claim 1, wherein the method is applied to both outgoing and incoming calls.

4. The method of claim 3, wherein the adding and storing of the calculated call duration is performed so that the calculated call duration is separately added according to whether the call is an outgoing call or an incoming call, when the calculated call duration is added to the total call duration with the calling partner.

5. The method of claim 1, further comprising adding the call duration, calculated after termination of the call, to a total call duration, and storing the added call duration in a total call duration area in the terminal.

6. The method of claim 1, further comprising classifying the call duration, calculated after the termination of the call, according to a day and time frame, adding the classified call duration to a total call duration according to the day and time frame, and storing the added call duration in a total call duration areas according to the day and time frame provided in the terminal.

7. The method of claim 6, wherein the classifying, adding and storing of the calculated call duration according to day and time frame is performed with respect to outgoing calls.

8. The method of claim 1, wherein the total call duration according to the calling partner is initialized at each month.

9. The method claim 1 further comprising storing the plurality of categories into the memory.

10. The method of claim 1 further comprising providing the user with one of the plurality of categories of the call duration including the category associated with the calling partner.

11. A method of using a call duration information of a call made between the user of a mobile communication terminal and a calling partner, comprising:
measuring the duration of the call after completion of the call;
identifying the calling partner of the call;
associating the duration of the call with the identified calling partner; and
providing the user with the duration of the call associated with the calling partner.

12. The method of claim 11 further comprising storing the associated duration of the call in a memory of the mobile communication terminal.

13. The method of claim 11 further comprising classifying the measured duration of the call into a plurality of categories including a category associated with the calling partner.

14. The method of claim 13, wherein the classifying includes categorizing the measured duration of the call according to a day of the week.

15. The method of claim 13, wherein the classifying includes categorizing the measured duration of the call according to a time frame.

16. The method of claim 13, wherein the classifying includes categorizing the measured duration of the call into one of an incoming call duration, an outgoing call duration and a total call duration.

17. The method of claim 11, wherein the identifying includes searching an address book of the mobile communication terminal.
